(19) United States
(12) Patent Application Publication
(10) Pub. No.: US 2025/0217120 A1
(43) Pub. Date: Jul. 3, 2025

(54) AI-BASED TECHNIQUES FOR GUIDING AN INSTRUCTION SCHEDULER

(71) Applicant: Advanced Micro Devices, Inc., Santa Clara, CA (US)

(72) Inventors: Jake Matthew Daly, San Diego, CA (US); Ian Charles Colbert, San Diego, CA (US); Andrei Rudolfovich Yershov, Boxborough, MA (US); Ryan Mitchell, Bellevue, WA (US); Robert A. Gottlieb, Boxborough, MA (US); Norman Rubin, Boxborough, MA (US)

(73) Assignee: Advanced Micro Devices, Inc., Santa Clara, CA (US)

(21) Appl. No.: 18/399,543

(22) Filed: Dec. 28, 2023

(51) Int. Cl. G06F 8/41

(52) U.S. Cl. CPC G06F 8/41

(57) ABSTRACT

Using artificial intelligence (AI)-based techniques to guide instruction scheduling in a compiler can improve the efficiency and code generation quality of the compiler. AI-guided scheduling of a basic block of a computer program can include obtaining first and second representations of the basic block; selecting K instruction scheduling procedures from a set of N instruction scheduling procedures based on analysis of the first representation of the basic block by a model, where 1≤K<N and N≥2; generating K candidate schedules of the basic block, including applying the K instruction scheduling procedures to the second representation of the basic block, and ordering the instructions of the second representation of the basic block in accordance with a candidate schedule included in the K candidate schedules.

### BACKGROUND

A compiler is a computer program that translates source code (e.g., a computer program encoded in one programming language) into target code (e.g., a functionally equivalent computer program encoded in another programming language). Many compilers translate source code in a high-level programming language into target code in a low-level programming language (e.g., assembly language) or into machine-executable object code. In addition to translating a computer program, some compilers modify the program to improve one or more of its characteristics (e.g., execution time, memory footprint, storage size, power consumption, etc.). The processes used by compilers to modify the program in pursuit of improved characteristics are often referred to as “compiler optimizations” (or simply “optimizations”). Instruction scheduling is one example of a compiler optimization. An instruction scheduler generally attempts to improve the execution time of a program by reordering its instructions (at compile time) to reduce pipeline stalls when the program is executed on a target processor.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1A shows an example of a set of instructions of a computer program.

FIGS. 1B and 1C each show an example schedule of the instructions of FIG. 1A.

FIG. 2 is a block diagram of an example of a compiler.

FIG. 3 is a block diagram of an example of a target code generator.

FIG. 4 is a block diagram of an example of a scheduler.

FIG. 5 is a flow diagram of an example model-based method for instruction scheduling.

FIG. 6 is a flow diagram of an example method for feature generation.

FIG. 7A shows an example of a representation of a basic block.

FIG. 7B is a dataflow diagram illustrating examples of data objects produced when the feature generation method of FIG. 6 is applied to the basic block representation of FIG. 7A.

FIG. 8 is a flow diagram of an example evaluation-based method for instruction scheduling.

FIG. 9 is a flow diagram of an example hybrid method for instruction scheduling.

FIG. 10 is a block diagram of an example of a computing device.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to artificial intelligence (AI)-based techniques for guiding an instruction scheduler. Many modern processors (e.g., graphics processing units) contain many highly specialized compute cores and memory hierarchies that tend to create intricate instruction- and data-level dependencies. In some examples, compilers for such processors rely on instruction schedulers to organize workloads in a way that most efficiently utilizes these hardware resources. However, achieving high efficiency often involves balancing conflicting objectives; for example, keeping register pressure low allows more threads to be launched, but launching too many threads can hurt instruction latency. In some examples, instruction schedulers simplify this complex optimization problem by (1) focusing on a single optimization objective at a time (e.g., reducing latency or increasing occupancy), and (2) using multiple heuristics to estimate runtime behavior from static analysis of source code. Even so, generating the optimal schedule for a program tends to be a complex and time-consuming task due to the large space of valid, functionally equivalent schedules.

Some instruction schedulers use an evaluation-driven scheduling technique to reduce latency, increase efficiency, or enhance other characteristics of the compiled program. In some examples, evaluation-driven scheduling involves iterating over the basic blocks in a program by traversing its control flow graph, independently scheduling each basic block N times using N distinct scheduling procedures to produce N candidate schedules S₁ . . . . S_{N}, analyzing the candidate schedules Sᵢ, assigning a score to each candidate schedule Sᵢ based on the analysis, and retaining the candidate schedule with the best score as the schedule for that basic block. Despite the basic block being scheduled N times using N distinct (e.g., independent) scheduling procedures, it is not uncommon for two or more candidate schedules to receive the same score, especially for smaller basic blocks. In some examples, if there are multiple best scores, the scheduler chooses (e.g., arbitrarily chooses) one of the best candidate schedules as the schedule for the basic block.

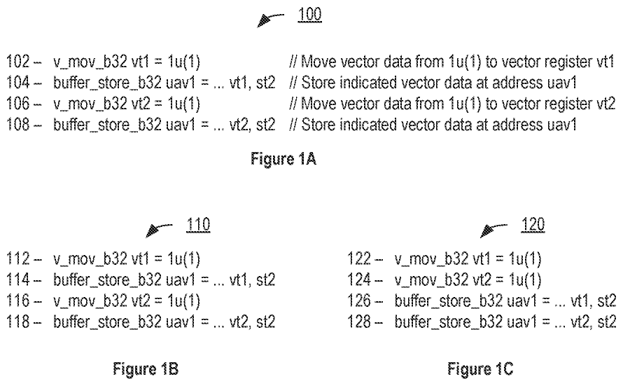

FIGS. 1A-1C illustrate an example of evaluation-driven scheduling in which a basic block 100 of instructions (102-108) of a computer program is scheduled using seven distinct scheduling procedures (N=7), four of which produce the first candidate schedule 110 of FIG. 1B and three of which produce the second candidate schedule 120 of FIG. 1C. Referring to FIG. 1A, the instructions (102-108) of the basic block 100 are encoded in the RDNA® instruction set (the instruction set of a family of graphics processing units (GPUs) produced by Advanced Micro Devices® (AMD) and having an RDNA-based architecture). Referring to FIG. 1B, the first candidate schedule 110 of the basic block leaves the instructions (112-118) in their original order. In some examples, the scheduler's analysis of the first candidate schedule 110 yields an estimate indicating that the instructions (112-118) will execute in 41 GPU cycles with 22 pipeline stalls, and the scheduler assigns the schedule 110 an overall score of 15. Referring to FIG. 1C, the second candidate schedule 120 of the basic block reorders the instructions (122-128) by moving instruction 124 ahead of instruction 126 in the list of instructions. In some examples, the scheduler's analysis of the second candidate schedule 120 yields an estimate indicating that the instructions (122-128) will execute in 20 GPU cycles with 10 pipeline stalls, and the scheduler assigns the schedule 120 an overall score of 12. In some examples, the scheduler selects the candidate schedule 120 as the schedule for the basic block, because the candidate schedule 120 has the lower overall score. The scores for the candidate schedules can be calculated using any suitable scoring algorithms and/or based on any suitable data (e.g., estimates of the performance or resource utilization of the basic block when scheduled in accordance with the candidate schedule).

In general, instruction scheduling is a computationally expensive and time-consuming phase of compiler execution that accounts for a significant portion of the compiler's overall latency and use of computational resources. As the foregoing example illustrates, the evaluation-driven scheduler's reliance on trial-and-error (e.g., blindly generating and evaluating N candidate schedules) can be highly inefficient, because N−1 of the N candidate schedules for each basic block are discarded, and because the different scheduling procedures do not necessarily produce different candidate schedules for a given basic block. The time and computational resources expended generating candidate schedules that are discarded or redundant can be significant, particularly for larger basic blocks. Thus, there is a need for faster, more efficient scheduling techniques.

The inventors have recognized and appreciated that model-guided scheduling techniques can greatly reduce the latency and computational demands of a compiler's instruction scheduling phase, yielding concomitant improvements to the compiler's overall latency and efficiency. In some examples, an AI model predicts which of the N instruction scheduling procedures is the 1-best scheduling procedure for a basic block (i.e., which of the N scheduling procedures will generate the best schedule for the basic block) before any candidate schedules for the basic block are generated. In some examples, the predicted 1-best scheduling procedure is then used to generate the schedule for that basic block, without using the N−1 other scheduling procedures to generate N−1 other candidate schedules. In some examples, the AI model is a transformer-based language model and includes a discriminative neural network. In some examples, the AI model predicts the 1-best scheduling procedure based on the compiler's intermediate representation (IR) of the basic block or based on features automatically derived by the scheduler from the IR of the basic block.

In some examples, rather than predicting the 1-best scheduling procedure for a basic block, an AI model predicts which K scheduling procedures of the N scheduling procedures (1<K<N) are the K-best scheduling procedures for a basic block (i.e., which K scheduling procedures will generate the best schedules for the basic block) before any candidate schedules for the basic block are generated. In some examples, the predicted K-best scheduling procedures are then used to generate K candidate schedules for that basic block, the K candidate schedules are evaluated (e.g., scored), and the best candidate schedule (e.g., the candidate schedule with the best score) is selected as the schedule for the basic block.

In some examples, one or more features may be generated based on the basic block (e.g., based on the IR of the basic block) and provided as input(s) to the AI model, rather than providing the entire basic block (e.g., the IR of the basic block) as input to the AI model. In some examples, the AI model may include one or more pooling layers between the input layer of the model's neural network and an output layer (e.g., linear layer) of the neural network. The use of such feature generation techniques and/or pooling layers can significantly reduce the footprint and latency of the AI model.

In some examples, a hybrid scheduler can use evaluation-driven scheduling for some basic blocks (e.g., smaller basic blocks) and model-guided scheduling for other basic blocks (e.g., larger basic blocks). In some examples, hybrid scheduling is more efficient and/or faster than fully evaluation-driven scheduling or fully model-guided scheduling because the trial-and-error inefficiency of evaluation-driven scheduling can be dwarfed by the modeling overhead of model-guided scheduling when scheduling smaller basic blocks, while the overhead of model-guided scheduling can be dwarfed by the inefficiency of evaluation-driven scheduling for larger basic blocks.

The inventors have observed that model-guided scheduling (using an AI model to predict the K-best scheduling procedures for a basic block, where 1≤K<N) can be more effective than model-driven scheduling (using an AI model to directly generate a schedule for a basic block). Model-driven schedulers often struggle with larger basic blocks because (1) supervised learning approaches rely on knowledge of optimal schedules that are often difficult or intractable to find, and (2) reinforcement learning approaches generally require a lot of training data (including runtimes of scheduled basic blocks) to successfully converge and the cost of evaluating runtimes quickly becomes intractable due to the non-trivial execution time of benchmark basic blocks, the enormous state space of legal instruction orderings, and the intricate inter-dependencies between concurrently executing workloads. In contrast, the model-guided scheduler can use data-driven techniques (e.g., machine learning) as a guiding force rather than a driving force, thereby combining the interpretability of procedure-based scheduling with the adaptability of data-driven evaluation of basic blocks.

The inventors have observed that model-guided scheduling can reduce the latency of the scheduling process by a substantial amount (e.g., up to 25% improvement (e.g., reduction) in scheduling time for a shader application, and more than 50% improvement in scheduling time for some individual basic blocks in a shader application). In some examples, the use of model-guided scheduling can also simplify the process of maintaining the compiler and lower the maintenance costs, because the scheduler can be ported to a new target processor by retraining (or fine-tuning) the AI model to predict the best procedure(s) for scheduling a basic block on the new target processor. Likewise, the scheduler can be updated to improve the scheduling of particular types of workloads by retraining (or fine-tuning) the AI model to predict the best procedure(s) for scheduling basic blocks of such workloads.

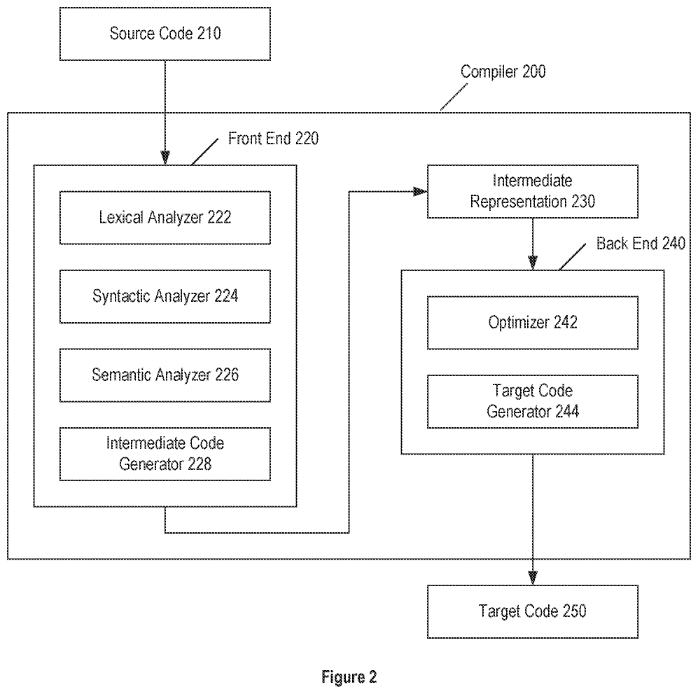

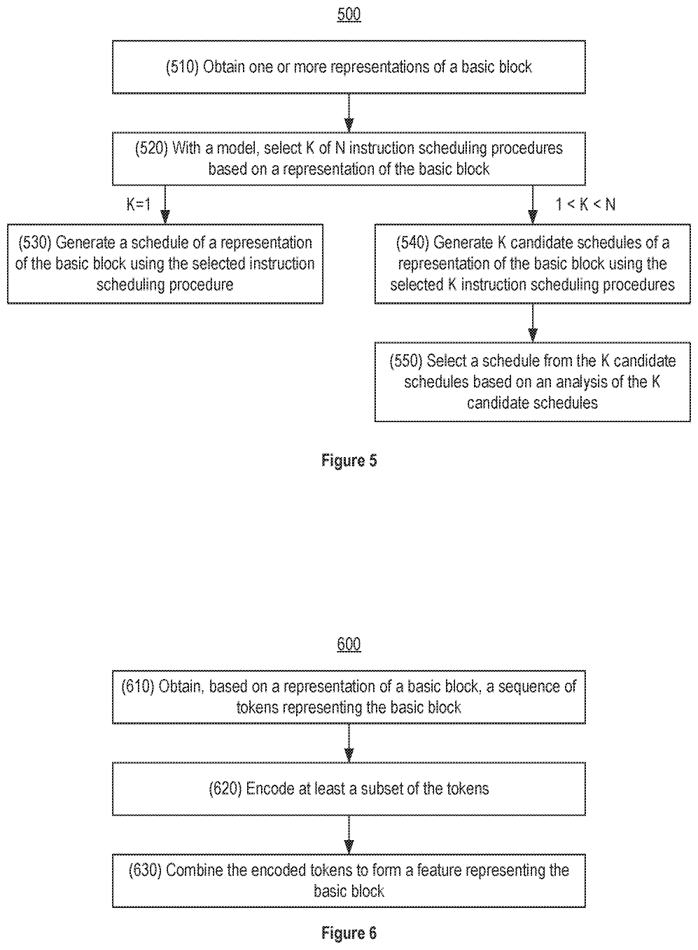

This disclosure provides, with reference to FIGS. 2-4 and 10, detailed descriptions of example systems for model-guided instruction scheduling. Detailed descriptions of corresponding computer-implemented methods are provided in connection with FIGS. 5-9.

In some aspects, the techniques described herein relate to a computer-implemented compilation method including: scheduling a basic block of a computer program, including: obtaining first and second representations of the basic block; selecting K instruction scheduling procedures from a set of N instruction scheduling procedures, wherein the selecting of the K instruction scheduling procedures is based on analysis of the first representation of the basic block by one or more models, wherein 1<K<N, and wherein N>2; generating K candidate schedules of the basic block, wherein generating the K candidate schedules includes applying the K instruction scheduling procedures to the second representation of the basic block, and ordering a plurality of instructions of the second representation of the basic block in accordance with a candidate schedule included in the K candidate schedules of the basic block; and generating a portion of target code of the computer program based on the second representation of the basic block; and outputting the portion of target code of the computer program.

In some aspects, the techniques described herein relate to a method, wherein the target code includes object code executable by a central processing unit (CPU), application processing unit (APU), graphics processing unit (GPU), tensor processing unit (TPU), field-programmable gate array (FPGA), programmable logic device (PLD), system-on-a-chip (SoC), network interface controller (NIC), data processing unit (DPU), data transform unit (DTU), hardware accelerator, and/or mobile processor.

In some aspects, the techniques described herein relate to a method, further including executing the object code by the CPU, APU, GPU, TPU, FPGA, PLD, SOC, NIC, DPU, DTU, hardware accelerator, and/or mobile processor.

In some aspects, the techniques described herein relate to a method, wherein the basic block is a first basic block, wherein scheduling the first basic block is performed by a first instruction scheduler of a compiler, and wherein scheduling a second basic block of the computer program includes, by a second instruction scheduler of the compiler: generating N candidate schedules of the second basic block, wherein generating the N candidate schedules includes applying the N instruction scheduling procedures to a representation of the second basic block; selecting a candidate schedule from the N candidate schedules of the second basic block based on an analysis of the generated N candidate schedules of the second basic block; and ordering a plurality of instructions of the representation of the second basic block in accordance with the selected candidate schedule.

In some aspects, the techniques described herein relate to a method, wherein the representation of the second basic block is a second representation, the method further including: assigning the first basic block to the first instruction scheduler based on one or more attributes of the first representation of the first basic block; and assigning the second basic block to the second instruction scheduler based on one or more attributes of the first representation of the second basic block not exceeding a threshold.

In some aspects, the techniques described herein relate to a method, wherein the one or more attributes of the first representation of the basic block include a number of instructions in the first representation of the basic block exceeding a threshold.

In some aspects, the techniques described herein relate to a method, wherein the selecting of the K instruction scheduling procedures from the set of N instruction scheduling procedures is performed after obtaining the analysis of the first representation of the basic block by the one or more models and before the generating of the K candidate schedules of the basic block.

In some aspects, the techniques described herein relate to a method, wherein the first representation of the basic block is encoded in a machine-independent intermediate representation (IR) of a compiler, and wherein the second representation of the computer program is encoded in a machine-dependent IR of the compiler, in a target language associated with the compiler, or in an instruction set of a target processor.

In some aspects, the techniques described herein relate to a method, wherein scheduling the basic block further includes obtaining the analysis of the first representation of the basic block, including: generating one or more features based on the first representation of the basic block; providing the one or more features as inputs to the one or more models; and obtaining an output of the one or more models, the output indicating the K instruction scheduling procedures.

In some aspects, the techniques described herein relate to a method, wherein generating the one or more features based on the first representation of the basic block includes generating a sequence of tokens based on the first representation of the basic block, encoding a plurality of tokens in the sequence of tokens, and combining the encoded plurality of tokens.

In some aspects, the techniques described herein relate to a method, wherein the one or more models include a neural network, and wherein the neural network includes at least one pooling layer disposed between an input layer and an output layer.

In some aspects, the techniques described herein relate to a method, wherein the target code includes a plurality of instructions executable by a first type of processor, wherein the one or more models have been trained to identify a K-best subset of the set of N scheduling procedures for scheduling a basic block for execution by the first type of processor, and wherein the method further includes retraining the one or more models to identify a K-best subset of the set of N scheduling procedures for scheduling a basic block for execution by a second type of processor.

In some aspects, the techniques described herein relate to a method, wherein retraining the one or more models includes fine-tuning the one or more models based on analysis of a plurality of candidate schedules of a plurality of basic blocks each encoded in a representation dependent on the second type of processor.

In some aspects, the techniques described herein relate to a method, further including: generating a first representation of the computer program based on source code of the computer program, the first representation of the computer program including first representations of a plurality of basic blocks including the first basic block; and generating a second representation of the computer program based on the first representation of the computer program, the second representation of the computer program including second representations of the plurality of basic blocks, the generating the second representation of the computer program including scheduling the plurality of basic blocks.

In some aspects, the techniques described herein relate to a compiler system including: at least one processor; and at least one computer-readable storage medium having encoded thereon instructions that, when executed by the at least one processor, cause the at least one processor to perform operations including: generating a first representation of a computer program based on source code of the computer program, the first representation of the computer program including first representations of a plurality of basic blocks including a basic block; generating a second representation of the computer program based on the first representation of the computer program, the second representation of the computer program including second representations of the plurality of basic blocks, the generating the second representation of the computer program including scheduling the plurality of basic blocks, wherein scheduling the basic block includes: selecting K instruction scheduling procedures from a set of N instruction scheduling procedures, wherein the selecting of the K instruction scheduling procedures is based on analysis of the first representation of the first basic block by one or more models, wherein 1<K<N, and wherein N>2, generating K candidate schedules of the basic block, wherein generating the K candidate schedules includes applying the K instruction scheduling procedures to the second representation of the basic block, and ordering a plurality of instructions of the second representation of the basic block in accordance with a candidate schedule included in the K candidate schedules of the basic block; generating target code of the computer program based on the second representation of the computer program; and outputting the target code of the computer program.

In some aspects, the techniques described herein relate to a system, wherein the target code includes object code executable by a central processing unit (CPU), application processing unit (first APU), accelerated processing unit (second APU), inference processing unit (IPU), graphics processing unit (GPU), tensor processing unit (TPU), field-programmable gate array (FPGA), programmable logic device (PLD), system-on-a-chip (SoC), network interface controller (NIC), data processing unit (DPU), data transform unit (DTU), hardware accelerator, and/or mobile processor.

In some aspects, the techniques described herein relate to a system, further including executing the object code by the CPU, first APU, second APU, IPU, GPU, TPU, FPGA, PLD, SoC, NIC, DPU, DTU, hardware accelerator, and/or mobile processor.

In some aspects, the techniques described herein relate to a system, wherein the at least one processor includes at least one first processor and at least one second processor, wherein the generating the K candidate schedules of the basic block is performed by the at least one first processor, and wherein scheduling the basic block further includes performing, by the at least one second processor, the analysis of the first representation of the basic block.

In some aspects, the techniques described herein relate to a system, wherein performing the analysis of the first representation of the basic block includes: generating one or more features based on the first representation of the basic block; providing the one or more features as inputs to the one or more models; and obtaining an output of the one or more models, the output indicating the K instruction scheduling procedures.

In some aspects, the techniques described herein relate to at least one computer-readable storage medium encoded with computer-executable instructions that, when executed by at least one computer, cause the at least one computer to perform operations including: scheduling a basic block of a computer program, including: obtaining first and second representations of the basic block; selecting K instruction scheduling procedures from a set of N instruction scheduling procedures, wherein the selecting of the K instruction scheduling procedures is based on analysis of the first representation of the basic block by one or more models, wherein 1<K<N, and wherein N>2; generating K candidate schedules of the basic block, wherein generating the K candidate schedules includes applying the K instruction scheduling procedures to the second representation of the basic block, and ordering a plurality of instructions of the second representation of the basic block in accordance with a candidate schedule included in the K candidate schedules of the basic block; and generating a portion of target code of the computer program based on the second representation of the basic block; and outputting the portion of target code of the computer program.

In some aspects, the techniques described herein relate to a computer-implemented compilation method including scheduling a basic block of a computer program. Scheduling the basic block includes obtaining first and second representations of the basic block; selecting an instruction scheduling procedure from a set of N instruction scheduling procedures, wherein the selecting of the instruction scheduling procedure is based on analysis of the first representation of the basic block by one or more models, wherein N is at least 2; and generating a schedule of the basic block, wherein generating the schedule includes applying the instruction scheduling procedure to the second representation of the basic block. The method further includes generating a portion of target code of the computer program based on the second representation of the basic block; and outputting the portion of the target code of the computer program.

In some aspects, selecting the instruction scheduling procedure from the set of N instruction scheduling procedures is performed after obtaining the analysis of the first representation of the basic block by the one or more models and before the generating of the schedule of the basic block. In some aspects, the target code includes a plurality of instructions executable by a first type of processor, wherein the one or more models have been trained to select a 1-best scheduling procedure from the set of N scheduling procedures for scheduling a basic block for execution by the first type of processor, and wherein the method further includes retraining the one or more models to identify a 1-best scheduling procedure from the set of N scheduling procedures for scheduling a basic block for execution by a second type of processor.

FIG. 2 is a block diagram of an example compiler 200. In some examples, the compiler 200 transforms (e.g., translates) source code 210 into target code 250. The compiler 200 can include open-source and/or closed-source software. In some examples, the compiler is a shader compiler for a GPU (e.g., a dedicated GPU). The source code 210 can include instructions encoded in a programming language (e.g., a high-level, human-readable programming language). The source code 210 can be organized in one or more files, and can specify one or more portions (e.g., functions, procedures, algorithms, interfaces, modules, data structures, tasks, etc.) of a computer program.

The target code 250 can include instructions encoded in another programming language (e.g., an assembly language of a specific type of processor) and/or in a machine-executable format (e.g., object code executable by a specific type of processor). For example, the target code can include assembly code or object code suitable for a central processing unit (CPU), application processing unit (APU), accelerated processing unit (APU), inference processing unit (IPU), graphics processing unit (GPU) (e.g., an integrated GPU (iGPU) or dedicated GPU (dGPU)), tensor processing unit (TPU), AI accelerator (e.g., vision processing unit, physical neural network, etc.), field-programmable gate array (FPGA), programmable logic device (PLD), system-on-a-chip (SoC), network interface controller (NIC), data processing unit (DPU), data transform unit (DTU), hardware accelerator (e.g., digital signal processor (DSP), network processor or network interface controller, cryptographic accelerator or crypto-processor, physics processing unit (PPU), etc.), mobile processor (e.g., a processor of a mobile computing device such as a laptop, tablet, smartphone, etc.), etc. Like the source code, the target code 250 can be organized in file(s) and can specify portion(s) of the computer program. The target code can be functionally equivalent to the source code. In some examples, the compiler 200 can transform the same source code 210 into different target code 250 executable by different types of processors.

In some examples, the compiler 200 includes a front end 220 and a back end 240. The front end 220 can transform source code encoded in one or more programming languages into an intermediate representation (IR) 230 (e.g., a language-independent IR). The back end 240 can transform the IR 230 into the target code 250. Optionally, the back end 240 can apply optimizations to the IR 230, which can enhance characteristics of the target code.

In some examples, the front end 220 analyzes the source code 210 and generates data objects (e.g., a symbol table, a control flow graph (CFG), etc.) that the back end 240 subsequently uses to optimize the IR 230 or translate the IR 230 into target code 250. For example, the front end 220 can include a lexical analyzer 222 that scans and tokenizes the source code 210 (e.g., translates the source code 210 into a sequence of tokens), a syntactic analyzer 224 that parses the tokens (e.g., constructs a parse tree) and assesses the syntactical validity of the source code 210 in view of the syntactical rules of the programming language in which the source code 210 is encoded, a semantic analyzer 226 that checks the parse tree for semantic errors, and an intermediate code generator 228 that translates the syntactically- and semantically-analyzed parse tree into the intermediate representation 230. In some examples, the front end 220 also includes an optimizer.

The back end 240 can transform the IR 230 into target code 250. In some examples, the back end 240 includes an optimizer 242 that can apply one or more compiler optimizations to the IR 230. Such compiler optimizations can include, without limitation, local optimizations (e.g., optimizations applied to individual basic blocks), intraprocedural optimizations (e.g., optimizations applied to individual functions or procedures), loop optimizations (e.g., optimizations applied to loop constructs), inter-procedural optimizations (e.g., optimizations applied to multiple functions or procedures, or to all of a program's source code), data flow optimizations, etc. Loop optimizations can include, for example, induction variable analysis, loop fission, loop fusion, loop inversion, loop interchange, loop-invariant code motion, loop nest optimization, loop reversal, loop unrolling, loop splitting, loop unswitching, software pipelining, automatic parallelization, etc. Data-flow optimizations can include common subexpression elimination, constant folding and propagation, induction variable recognition and elimination, alias classification and point analysis, dead-store elimination, etc.

In some examples, the back end 240 includes a target code generator 244. The target code generator 244 can transform the IR 230 (e.g., the IR produced by the front end 220, or the optimized IR produced by the optimizer 242) into target code 250. In some examples, the IR 230 includes a set of basic blocks. A control flow graph (CFG) can indicate, at the most granular level, the flow-of-control relationships between and among the basic blocks, and can also indicate, in aggregate, the control flow paths that can be traversed during execution of the program being compiled. In some examples, each basic block includes a sequence of one or more instructions and has a single entry-point (the first instruction of the basic block) and a single exit point (the last instruction of the basic block). More formally, in some examples, the instructions in a basic block satisfy the requirements that (1) each instruction in the sequence dominates all subsequent instructions in the sequence, and (2) no other instruction executes between any two adjacent instructions in the sequence.

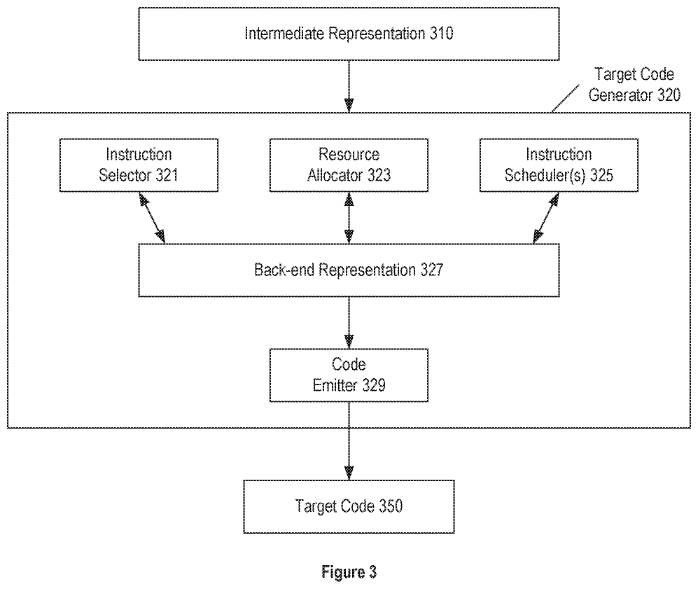

An example architecture of a target code generator 320 (e.g., target code generator 244) is shown in FIG. 3. In some examples, the target code generator 320 transforms the IR 310 (e.g., IR 230) into a back-end representation 327, and then transforms the back-end representation (BR) of the program into target code 350 (e.g., target code 250). In some examples, the BR 327 is initially a machine-independent IR of the program (e.g., the IR 310). The machine-independent IR can be independent of the language of the source code 210, independent of the language of the target code 350, and/or independent of the architecture of the target processor(s) on which the target code 350 will execute. As the target code generator 320 processes the BR 327, the BR 327 can be transformed into a machine-dependent IR. The machine-dependent IR can be dependent on (e.g., can closely resemble) the language of the target code 350 and/or be dependent on the architecture of the target processor(s) on which the target code 350 will execute. In some examples, the final state of the BR is identical to the target code 350.

In some examples, the target code generator 320 includes components that process the BR 327. These components can include, for example, an instruction selector 321, a resource allocator 323, and instruction scheduler(s) 325. The instruction selector 321 can translate the instructions of the BR 327 from a higher level to a lower level. For example, the instruction selector 321 can translate the instructions of the BR 327 from a machine-independent IR into a machine-dependent IR (e.g., without imposing resource constraints such as a finite number of registers) or into assembly language instructions. The resource allocator 323 can impose resource constraints on the BR 327 (e.g., by mapping the instructions of the BR 327 to a finite number of registers).

The instruction scheduler(s) 325 can change the order (e.g., program order) of the instructions of the BR 327. As used herein, “program order” refers to the ordered sequence of instructions within the program or a portion thereof (e.g., within a basic block). In some examples, a scheduler 325 performs local scheduling (or “basic block scheduling”), such that instructions are not reordered across the boundaries between basic blocks. In some examples, a scheduler 325 performs global scheduling, such that instructions can be reordered across the boundaries between basic blocks. Some examples of local scheduling techniques are described in further detail below.

In some examples, an instruction scheduler 325 reorders a program's instructions when the reordering is expected to improve the program's runtime performance (e.g., by reducing pipeline stalls, increasing resource utilization, exposing instruction-level parallelism, overlapping execution of instructions, etc.). In some examples, a scheduler can reorder instructions only if the reordering preserves the original read-after write (RAW), write-after-read (WAR), and write-after-write (WAW) data dependencies among the instructions, such that the reordering does not alter the functionality of the program.

In some examples, the components of the target code generator 320 can process the BR 327 any suitable number of times, in any suitable sequence. For example, the instruction selector 321 can perform instruction selection on the BR 327, then the resource allocator 323 can allocate resources (e.g., registers) to the instructions of the BR 327, and then the instruction scheduler(s) 325 can schedule the instructions of the BR 327. In other examples, resource allocation is performed after instruction scheduling. In some examples, resource allocation is performed both before and after instruction scheduling. In some examples, instruction scheduling is performed before instruction selection, or both before and after instruction selection.

In some examples, the target code generator includes a code emitter 329, which outputs the target code 350. In examples in which the final state of the BR 327 is the target code 350, the code emitter 329 can be omitted. In examples in which the final state of the BR 327 is not the target code 350, the code emitter translates the BR 327 into the target code. In some examples, the code emitter 329 includes an assembler, which translates assembly code (e.g., the final state of BR 327) into object code.

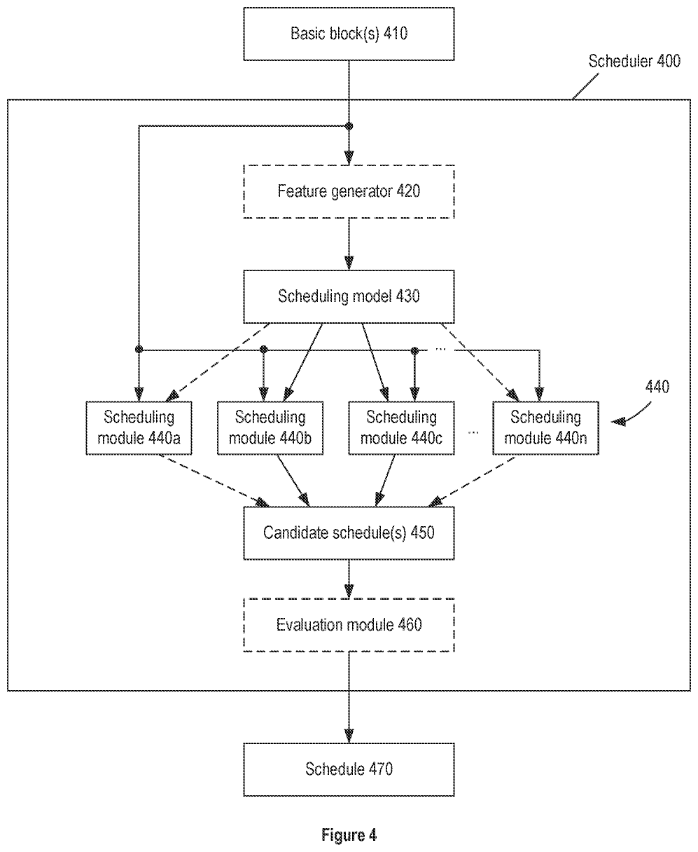

FIG. 4 is a block diagram of an example scheduler 400 (e.g., instruction scheduler 325). In some examples, one or more basic blocks 410 are provided as input to the scheduler 400, which performs scheduling (e.g., local scheduling) operations to generate a schedule 470 for each basic block 410. The instructions of the basic block(s) 410 can be encoded in any suitable representation, for example, machine-independent IR (e.g., IR 310), back-end representation 327 (e.g., machine-dependent IR, the compiler's target language, etc.). In some examples, two or more encodings of a basic block 410 are provided as input to the scheduler 400 (e.g., the basic block's representation in IR 310 and in BR 327). The schedule 470 of a basic block 410 can include an ordered sequence of the instructions of the basic block encoded in any suitable representation (e.g., BR 327). In some cases, the scheduler 400 generates a schedule 470 for a basic block 410 without reordering the instructions of the basic block (i.e., the sequence of instructions in the representation of a basic block 410 provided as input to the scheduler 400 and the sequence of instructions in the schedule 470 of the basic block provided as output by the scheduler 400 are identical). In other cases, the scheduler 400 generates a schedule 470 for a basic block 410 by reordering the instructions of the basic block (i.e., the sequence of instructions in the representation of a basic block 410 provided as input to the scheduler 400 and the sequence of instructions in the schedule 470 of the basic block provided as output by the scheduler 400 are not identical).

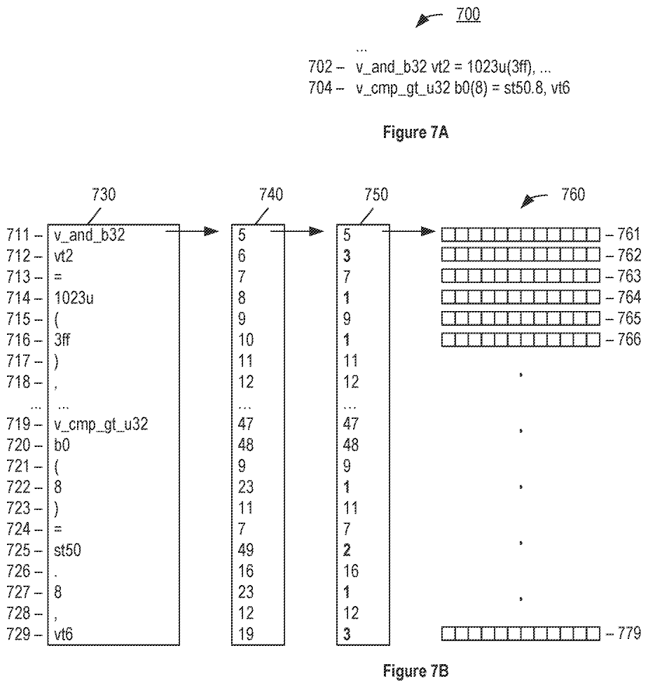

In some examples, the scheduler 400 includes a feature generator 420. The feature generator 420 can generate one or more features based on the representation(s) of the basic block 410 (e.g., extract one or more features from the basic block 410) and provide those feature(s) as input to a scheduling model 430. In some examples, the feature generator 420 encodes attributes of the basic block 410 in the generated features, which can reduce the complexity or improve the performance of the scheduling model 430. Some examples of feature generation techniques are described below with reference to FIGS. 6, 7A, and 7B. In some examples, the feature generator 420 is omitted, such that one or more representations of the basic block 410 are provided as input to the scheduling model 430. For example, the IR 310 of a basic block 410 may be provided as input to the scheduling model 430.

In some examples, the scheduler 400 includes a scheduling model 430, which predicts the K-best scheduling procedures from a larger set of N possible scheduling procedures for a basic block 410. In some examples, the scheduling model predicts the K-best scheduling procedures for the basic block 410 before any of the N scheduling procedures is used to generate a candidate schedule for the basic block. The scheduling model 430 can make this prediction based on input representing the basic block (e.g., features generated by feature generator 420 for the basic block and/or the IR 310 of the basic block). In some examples, the scheduling model 430 can make this prediction before any of the N scheduling procedures are used to generate candidate schedules for the basic block 410. In some examples, K=1 and N≥2 (i.e., the scheduling model 430 predicts the best scheduling procedure for the basic block from a set of two or more (N) possible scheduling procedures). In some examples, K>1 and N≥3 (i.e., the scheduling model 430 predicts that the best scheduling procedure for the basic block is one of two or more (K) scheduling procedures selected from a set of three or more (N) possible scheduling procedures).

Any suitable criteria can be used to determine whether any one of N possible scheduling procedures for a basic block is the “best” scheduling procedure or one of the “K-best” scheduling procedures for that basic block. In some examples, the best scheduling procedure for a basic block is the scheduling procedure that, when applied to that basic block, generates the “best schedule” for the block. The “best schedule” can be the schedule that maximizes or minimizes any suitable performance metric associated with the execution of the basic block on the target processor, relative to the set of schedules that would be generated by applying each of the N possible scheduling procedures to the basic block. Some non-limiting examples of performance metrics can include the number of pipeline stalls produced when executing (or simulating the execution of) the scheduled basic block on the target processor, the number of processor clock cycles used when executing (or simulating the execution of) the scheduled basic block on the target processor, any measure of the scheduled basic block's actual or simulated resource utilization (e.g., number of registers used, number of thread contexts used, etc.) on the target processor, a score calculated based on the foregoing metrics or other suitable metrics, etc.

Still referring to FIG. 4, the scheduler 400 can select, from the set of N possible scheduling procedures, the subset of scheduling procedures predicted to be the K-best procedures by the scheduling model 430, and apply the selected scheduling procedures to the basic block 410 to generate K candidate schedules for the basic block. In FIG. 4, the N possible scheduling procedures are represented by scheduling modules 440a, 440b, 440c, . . . 440n, and the selection of the predicted K-best procedures is represented by the solid (not dashed) lines extending from the scheduling model 430 to the corresponding scheduling modules 440. Thus, in the example of FIG. 4, the scheduling model 430 predicts that the scheduling procedures implemented by scheduling modules 440b and 440c are the K-best (2-best) scheduling procedures, and the scheduler applies those two scheduling procedures to the basic block 410 to generate two candidate schedules 450 for the basic block.

In some examples, the scheduling model 430 predicts the 1-best scheduling procedure for the basic block 410, the scheduler 400 selects the scheduling procedure predicted to be the 1-best and applies that scheduling procedure to the basic block 410, and a single candidate schedule 450 for the basic block is generated. In such examples, the scheduler 400 outputs the candidate schedule 450 as the actual schedule 470 for the basic block 410.

In some examples, the scheduling model 430 predicts the K-best scheduling procedures for the basic block 410 (K>2), the scheduler 400 selects the scheduling procedures predicted to be the K-best and applies those scheduling procedures to the basic block 410, and K candidate schedules 450 for the basic block are generated. In such examples, an evaluation module 460 of the scheduler 400 can analyze (e.g., evaluate) the generated candidate schedules 450, select the best schedule among the candidate schedules, and output the best candidate schedule as the actual schedule 470 for the basic block 410. The evaluation module 460 can use any suitable techniques to determine which schedule is the best of the K candidate schedules. In some examples, the evaluation module 460 determines (e.g., estimates) performance metrics corresponding the execution of the basic block 410 in accordance with each of the K candidate schedules. Some non-limiting examples of suitable performance metrics are described above. In some examples, the evaluation module 460 determines the performance metrics corresponding to execution of a basic block 410 scheduled in accordance with a candidate schedule 450 by simulating the execution of the scheduled basic block on the target processor (e.g., using a trace-driven or cycle-accurate architecture simulator). In some examples, the evaluation module 460 determines the performance metrics corresponding to execution of a basic block 410 scheduled in accordance with a candidate schedule 450 using one or more models or analytical techniques.

In some examples, the scheduling model 430 and the scheduling procedures represented by the scheduling modules 440 operate on the same representation of a basic block 410 (e.g., the machine-independent IR, machine-dependent IR, back-end representation (BR), target code, etc.). In some examples, the scheduling model 430 operates on a first representation of the basic block 410 (e.g., machine-independent IR, machine-dependent IR, BR, or one or more features generated by feature generator 420), and the scheduling procedures operate on a second representation of the basic block 410 (e.g., machine-dependent IR, BR, or target code). Configuring the scheduling model 430 to operate on a higher-level, less machine-dependent representation of the basic block 410 (e.g., machine-independent IR or features generated by the feature generator 420 based on the machine-independent IR) and the scheduling procedures to operate on a lower-level, more machine-dependent representation of the basic block 410 (e.g., machine-dependent IR, BR, or target code) can facilitate efficient model development, because some components of the scheduling model 430 (e.g., stages or layers of the scheduling model that analyze the basic block 410) can be reused in different versions of the scheduling model 430 that are tailored to predict the K-best scheduling procedures for scheduling the basic block on different target processors, with little or no retraining or fine-tuning of the reused model components. On the other hand, configuring the scheduling model 430 and the scheduling procedures to operate on the same, lower-level representation of the basic block 410 (or configuring the scheduling model 430 to operate on features generated from the same lower-level representation of the basic block on which the scheduling procedures operate) can improve the accuracy of the scheduling model 430, because the lower-level representation of the basic block can expose relevant information that might otherwise be difficult for the scheduling model 430 to learn or infer.

Still referring to FIG. 4, each of the scheduling modules 440 can be configured to apply any suitable instruction scheduling procedure to the basic block 410. In some examples, an instruction scheduling procedure involves building a dependency graph for the basic block. The dependency graph may be, for example, a directed acyclic graph (“DAG”) in which nodes represent instructions and edges between nodes represent dependencies (e.g., data flow dependencies or precedence dependencies) between the corresponding instructions. In some examples, an instruction scheduling procedure further involves determining a topological ordering of the dependency graph and ordering the instructions of the basic block according to the topological ordering of the corresponding nodes. In some examples, different scheduling procedures use different scheduling heuristics to determine a valid topological ordering (i.e., an ordering that does not violate the RAW, WAW, or WAR dependencies in the dependency graph). In some examples, different scheduling procedures use the same scheduling heuristics to determine a valid topological ordering but prioritize or weight the outputs of those scheduling heuristics differently. Each scheduling procedure can use any suitable scheduling heuristic(s) to identify the next instruction in a valid topological ordering of the nodes of the dependency graph, and each scheduling procedure can weight or prioritize the outputs of its scheduling heuristic(s) in any suitable way. Some non-limiting examples of scheduling heuristics can include (1) heuristics that prioritize avoiding stall cycles by attempting to first schedule the instructions with the longest execution times (e.g., “earliest execution time,” “interlock with immediate successor,” “highest latency instruction,” etc.), (2) heuristics that prioritize increasing the utilization of functional units in a superscalar processor by attempting to scheduling consecutive instructions that execute on different types of functional units (e.g., “alternate type,” etc.), (3) heuristics that prioritize scheduling of instructions on the basic block's critical path (e.g., “maximum path length to a leaf,” “maximum delay to a leaf,” “maximum path length from root,” “maximum delay from root,” “earliest start time,” “latest start time,” “longest latency weighted path to root,” etc.), (4) heuristics that prioritize scheduling instructions that expose additional parallelism (e.g., by increasing the number of instructions in the set of candidates to be scheduled next) (e.g., “number of immediate successors,” “sum of delays to immediate successors,” “number of nodes with a single immediate predecessor,” “number of uncovered immediate successors,” “most descendants,” etc.), (5) heuristics that prioritize scheduling instructions such that progress through the dependency graph is balanced (e.g., “number of immediate predecessors,” “number of successors,” etc.), (6) heuristics that prioritize reducing register pressure by decrease the number of registers that are in use simultaneously (e.g., “number of registers born,” “number of registers killed,” “liveness,” etc.), etc. Descriptions of many of the foregoing scheduling heuristics can be found in E. Samuelsson, A Comparison of List Scheduling Heuristics in LLVM Targeting POWER8, M.S. Thesis, Department of Computer Science, Lund University, December 2020.

Still referring to FIG. 4, the scheduling model 430 can be any suitable model trained using any suitable techniques. In some examples, the scheduling model 430 includes a discriminative neural network (NN) that predicts the K-best scheduling procedures for a basic block 410 based on a representation of the basic block. In some examples, the discriminative NN includes a transformer-based language model. Any suitable transformer-based architecture can be used, e.g., an open source PyTorch transformer architecture, BERT (Bidirectional Encoder Representations from Transformers, introduced by Google), GPT-N (Generative Pre-trained Transformer, introduced by OpenAI), Transformer-XL or XLNet (introduced by Google and Carnegie Mellon University), XLM (Cross-lingual Language Model, introduced by Facebook), ROBERTa (Robustly Optimized BERT pretraining Approach, introduced by Facebook), Linformer (introduced by Facebook), DistilBERT (Distilled BERT, introduced by HuggingFace), etc. In some examples, the transformer-based language model includes an attention mechanism (e.g., scaled dot-product attention, multi-head attention, masked attention, etc.).

In some examples, the transformer-based language model has an encoder-decoder architecture (e.g., the model includes an encoder, one or more hidden neural network layers, and a decoder). In some examples, the transformer output is a sequence of encodings (e.g., embeddings) (referred to herein as “EncBB”) representing the basic block 410. For example, EncBB for a basic block 410 can include one encoding for each instruction or each token in the basic block. However, the length of a basic block can be as short as 1-2 tokens or as long as thousands of instructions (or more). Thus, the size of EncBB can be roughly proportional to the number of instructions or tokens in the basic block.

In some examples, the transformer-based language model further includes a linear layer that serves as a decoder. The linear layer can predict the K-best scheduling procedures for a basic block 410 based on EncBB. However, in some examples, the computational resources (e.g., memory, processor cycles, etc.) used by the linear layer to produce a prediction can be substantial and can increase as the size of EncBB increases.

In some examples, the scheduling model 430 further includes one or more pooling layers inserted between the transformer and the linear layer. In some examples, the pooling layer(s) can reduce the size of EncBB (e.g., by down-sampling the transformer's output), thereby significantly reducing the computational resource requirements of the linear layer, the footprint of the scheduling model 430, and/or the inference latency of the scheduling model 430. In some examples, the pooling layer(s) assign the decoder-provided representations (EncBBs) of basic blocks 410 to classes (e.g., “bin”) based on their size, and down-sample the larger EncBBs, such that the pooled representations of all basic blocks are the same length or approximately the same length. The pooling layer(s) may down-sample the EncBBs using any suitable down-sampling, compression, or aggregation technique (e.g., max pooling, average pooling, etc.). In some examples, the pooling layer(s) can add padding to short EncBBs.

An example has been described in which the scheduling model 430 includes a transformer-based language model. In some examples, the scheduling model 430 does not include a transformer-based language model. For example, the scheduling model 430 can include a recurrent neural network (RNN) (e.g., a long short-term memory (LSTM) RNN, a gate recurrent unit (GRU) RNN, etc.).

More generally, the scheduling model 430 can include any suitable generative or predictive models. Predictive models can analyze historical data, identify patterns in that data, and make inferences (e.g., produce predictions or forecast outcomes) based on the identified patterns. Some non-limiting examples of predictive models include neural networks (e.g., deep neural networks (DNNs), convolutional neural networks (CNNs), recurrent neural networks (RNNs), learning vector quantization (LVQ) models, etc.), regression models (e.g., linear regression models, logistic regression models, linear discriminant analysis (LDA) models, etc.), decision trees, random forests, support vector machines (SVMs), naïve Bayes models, classifiers, etc. Generative models can analyze existing content, identify patterns in the content, and combine or modify the identified patterns to generate new content. The new content can include text, images, video, music, or any other suitable type of content. Some non-limiting examples of generative models include generative adversarial networks (GANs), variational autoencoders (VAEs), autoregressive models (e.g., large language models (LLMs)), recurrent neural networks (RNNs), transformer-based models, reinforcement learning models for generative tasks, etc. Transformer-based models generally have an encoder-decoder architecture, use an attention mechanism (e.g., scaled dot-product attention, multi-head attention, masked attention, etc.) to model the relationships between different elements in a sequence of content, and perform well when processing long sequences of content. Some non-limiting examples of transformer-based models include Generalized Pre-trained Transformer 4 (GPT-4), DALL-E3, etc.

In some examples, the scheduling model 430 predicts the K-best scheduling procedures for each individual basic block 410 independently (“block-by-block inference” or “single-block inference”). In some examples, the scheduling model 430 predicts the K-best scheduling procedure for a set of two or more basic blocks 410 (“batch inference”). When batch inference is performed, the scheduler 400 can generate an aggregate encoding of the set of basic blocks (e.g., by concatenating the encodings of the individual basic blocks) and predict the K-best scheduling procedure for those basic blocks based on the aggregate encoding (or based on a pooled representation of the aggregate encoding).

In some examples, the feature generator 420 (if any) and the scheduling model 430 collectively constitute a trained model (e.g., trained AI model). Any suitable techniques, including supervised, unsupervised, self-supervised, and semi-supervised techniques can be used to train the AI model. In some examples, training the AI model involves obtaining a scheduling dataset, fitting the AI model to a training portion of the scheduling dataset (“training data”), validating the AI model on a validation portion of the scheduling dataset (“validation data”), and testing the AI model on a testing portion of the scheduling dataset (“testing data”). The scheduling dataset can include input samples of representations of basic blocks 410 (e.g., samples of the same types of basic block representations provided as input to the scheduler 400), and corresponding output samples (e.g., ground-truth output samples) indicating the K-best scheduling procedures for scheduling the basic blocks to execute on a specific target processor. In some examples, such output samples are obtained by applying the N scheduling procedures corresponding to the N scheduling modules 440 to the basic block and evaluating the resulting N candidate schedules to determine which K candidate schedules are the best procedures for scheduling the basic block to execute on the specific target processor.

Fitting the AI model to the training data can involve adjusting values of parameters of the AI model (e.g., parameter values of the feature generator 420 and/or the scheduling model 430) such that the AI model learns the relationship between the input and output samples of the training portion of the dataset. Validating the AI model on the validation data can involve using the AI model to generate output samples corresponding to the input samples of the validation data and assessing the AI model's performance based on a comparison of the model-generated output samples and the corresponding ground-truth output samples. In some examples, the training and validation steps are performed iteratively until the AI model exhibits an acceptable level of performance. Testing the AI model on the testing data can involve using the AI model to generate output samples corresponding to the input samples of the testing dataset, where the input samples of the testing dataset have not been used during the training and validation steps.

In some examples, training the AI model can further include retraining (e.g., fine-tuning) the trained AI model to predict the K-best scheduling procedures for scheduling basic blocks for execution on a second target processor, where the AI model was previously trained to predict the K-best scheduling procedures for scheduling basic blocks for execution on a first target processor. Fine-tuning the AI model can involve performing the training process again, using a scheduling dataset specific to the second target processor, with a subset of the AI model's parameters frozen (not permitted to change values) and another subset of the AI model's parameters unfrozen (permitted to change values). Likewise, the AI model can be retrained (e.g., fine-tuned) to predict the K-best scheduling procedures (1) for specific types of basic blocks (e.g., basic blocks for which the AI model's predictions of the K-best scheduling procedures have not been consistently accurate), (2) for new versions of the compiler (which can, for example, generate representations of a basic block that differ from the representations generated by older versions of the compiler, particularly when compiler optimizations are applied), or (3) in any other suitable scenario.

FIG. 5 is a flow diagram of an example computer-implemented, model-based method 500 for instruction scheduling. The scheduling method 500 can be performed, for example, by the scheduler 400. The scheduler can perform scheduling method 500 to schedule the instructions of a basic block (e.g., to generate a schedule 470 of the instructions of a basic block 410). In some examples, the scheduling method 500 includes steps 510-530. In some examples, the scheduling method includes steps 510, 520, 540, and 550. Some examples of the steps of the scheduling method 500 are described in further detail below.

In step 510, the scheduler obtains one or more representations of a basic block. The representations of the basic block can include, for example, for example, a set of instructions encoded in machine-independent IR (e.g., IR 310), back-end representation 327 (e.g., machine-dependent IR, the compiler's target language, etc.), features generated based on another representation of the basic block (e.g., by feature generator 420), or any other suitable representation. In some examples, the scheduler obtains a first representation (e.g., machine-independent IR 310) and a second representation (e.g., BR 327) of the basic block.

The scheduler can obtain the representation(s) of the basic block using any suitable techniques. In some examples, a front end 220 of a compiler 200 analyzes source code of a computer program and generates a machine-independent IR of the computer program which includes a set of basic blocks. In some examples, a compiler optimizer 242 performs optimizations on the machine-independent IR. The basic block can be any basic block in the set of basic blocks generated by the compiler, and the first representation of the basic block can be the machine-independent IR of that basic block generated by the front end 220 or by the optimizer 242. In some examples, a target code generator 244 of a back end 240 of the compiler generates the second representation of the basic block based on its first representation. In some examples, the second representation of the basic block is the back-end representation 327 at any stage of processing by the target code generator 244 (e.g., before or after one or more iterations of instruction selection, before or after one or more iterations of resource allocation, before any iterations of instruction scheduling, after one or more prior iterations of instruction scheduling, etc.).

In step 520, the scheduler selects K instruction scheduling procedures from a set of N instruction scheduling procedures (1≤K<N) based on a representation (e.g., the first representation) of the basic block. The scheduler can select the K instruction scheduling procedures with a model (e.g., scheduling model 430), and can make the selection prior to the use of any of the N instruction scheduling procedures to generate a schedule for the basic block. In some examples, the scheduler provides the first representation of the basic block as input to the model. In some examples, the scheduler generates one or more features based on the first representation of the basic block (e.g., using feature generator 420) and provides the feature(s) as input to the model. An example of a feature generation process performed by the feature generator 420 is described below with reference to FIGS. 6, 7A, and 7B.

For examples in which K=1, the model predicts which of the N instruction scheduling procedures is the 1-best scheduling procedure for the basic block, and the method advances to step 530. For examples in which K>1, the model predicts the K-best scheduling procedures for the basic block, and the method advances to step 540.

For examples in which K>1, in step 530, the scheduler generates a schedule of the basic block using the instruction scheduling procedure selected in step 520. In some examples, generating the schedule of the basic block involves generating a schedule of a representation (e.g., the second representation) of the basic block. In some examples, generating a schedule of a representation of the basic block involves applying the selected instruction scheduling procedure to the representation of the basic block. In some examples, the ordering of the basic block's instructions in the schedule differs from the ordering of the instructions in the representation of the basic block. In some examples, the ordering of the instructions in the schedule differs from the ordering of the instructions in the representation of the basic block if the relative ordering of any two instructions in the schedule differs from their relative ordering in the representation of the basic block. In some examples, the ordering of the basic block's instructions in the schedule is the same as the ordering of the instructions in the representation of the basic block. In some examples, the scheduler provides the generated schedule as the schedule for the basic block.

For examples in which 1<K<N, in step 540, the scheduler generates K candidate schedules of the basic block using the K instruction scheduling procedures selected in step 530. In some examples, generating the K candidate schedules of the basic block involves generating K candidate schedules of a representation (e.g., the second representation) of the basic block. In some examples, generating K candidate schedules of a representation of the basic block involves applying the selected K instruction scheduling procedures to the representation of the basic block. In some examples, the K candidate schedules specify K distinct orderings of the instructions of the representation of the basic block. In some examples, two or more of the K candidate schedules specify the same ordering of the instructions. In some examples, each of the K candidate schedules specifies an ordering of the instructions distinct from the ordering in the representation of the basic block. In some examples, at least one of the K candidate schedules specifies the same ordering of instructions as the representation of the basic block.

In step 550, the scheduler selects a candidate schedule for the basic block from the set of K candidate schedules and provides the selected schedule as the schedule for the basic block. In some examples, the scheduler analyzes the candidate schedules (e.g., obtains and evaluates metrics associated with the candidate schedules) and selects the best candidate schedule based on that analysis. Some examples of techniques for analyzing candidate schedules are discussed above.

FIG. 6 is a flow diagram of an example method 600 for feature generation. In some examples, the feature generation method 600 is performed by the feature generator 420 of the scheduler 400. In some examples, the feature generator 420 performs the feature generation method 600 to generate one or more features characterizing a basic block based on a representation of the basic block (e.g., based on the first representation of a basic block obtained at step 510 of the scheduling method 500). In some examples, the feature generation method 600 includes steps 610-630. Some examples of steps of the feature generation method 600 are described below.

Some aspects of examples of the feature generation method 600 are described with reference to FIGS. 7A and 7B. FIG. 7A shows a representation 700 of a basic block with two instructions 702 and 704. The representation 700 can be an intermediate representation of the basic block (e.g., a machine-independent IR). Instruction 702 is a “bitwise AND” instruction, which indicates that the bitwise AND of two vectoroperands is calculated and stored in vector register “vt2,” where the first vector operand is the immediate value “1023u(3ff)” and the second vector operand is elided for ease of illustration. Instruction 704 is a “vector comparison” instruction, which indicates that the vector comparison “x3>x4” is determined and stored at memory address “b0(8),” where “x3” is the value of scalar register “st50.8” and “x4” is the value in vector register “vt6.” FIG. 7B shows a dataflow diagram illustrating examples of data objects that can be produced when feature generation method 600 is applied to the representation 700 of a basic block.

Referring again to FIG. 6, in step 610, the feature generator 420 obtains a sequence of tokens representing a basic block based on a representation of the basic block. In FIG. 7B, a sequence 730 of tokens (711-729) corresponding to the representation 700 of a basic block is shown. The tokens can be units in the grammar of the representation of the basic block. For example, tokens can be opcodes, operators, memory locations, memory types (e.g., registers, scalar registers, vector registers, etc.), units of punctuation (e.g., ! @ #$ % \hat{ } & * ( ) { }:” < > ?, . /), literals, data types, etc. In some examples, the representation of the basic block already includes a sequence of tokens in the grammar of a programming language (e.g., the compiler's machine-independent IR). Thus, obtaining the sequence 730 of tokens can involve retrieving the sequence 730 of tokens from a computer-readable medium. In some examples, obtaining the sequence of tokens involves traversing a parse tree corresponding to the representation of the basic block. In some examples, obtaining the sequence of tokens involves scanning the representation 700 of the basic block for tokens of a grammar, and creating a sequence (e.g., array) of tokens in the same order that those tokens appear in the basic block's representation. Any suitable technique for obtaining the sequence of tokens representing the basic block can be used.

In step 620, the feature generator 420 encodes at least a subset of the tokens (711-729) in the sequence 730 of tokens. In some examples, encoding a sequence of tokens (e.g., sequence 730 or a subset thereof) involves generating a coded sequence 740 based on the token sequence, where each element of the coded sequence 740 is a code (e.g., integer) representing the corresponding token in the token sequence. In some examples, each unique token in the token sequence 730 is assigned a unique code in the code sequence 740. For example, referring to FIG. 7B, token 711 (the opcode ‘v_and_b32’) is assigned the code ‘5’, and tokens 713 and 724 (the assignment operator ‘=’) is assigned the code ‘7’.

In some examples, encoding a sequence of tokens (e.g., sequence 730 or a subset thereof) involves generating a coded, normalized sequence 750 based on the token sequence, where each element of the coded, normalized sequence 750 is a code (e.g. integer) representing the corresponding token in the token sequence. The feature generator 420 can generate the coded, normalized sequence 750 based on the token sequence 730 (without generating the coded sequence 740), or based on the token sequence 730 and the coded sequence 740. In some examples, unique tokens in the token sequence 730 are normalized, and each unique normalized token is assigned a unique code in the normalized sequence 750. In the example of FIG. 7B, token 712 (‘vt2’) and token 729 (‘vt6’) are mapped to a normalized token (e.g., ‘vtx’), and the normalized tokens are both assigned the code ‘3’.

Any suitable techniques can be used to normalize the token sequence 730 (or a subset thereof). In some examples, all constant values of all data types or all constant values of each individual data type are mapped to the same normalized token (or normalized code). In some examples, all registers of any type or all registers of each individual type (e.g., scalar registers, vector registers, etc.) are mapped to the same normalized token (or normalized code). In other examples, different registers are mapped to different normalized tokens (or normalized codes). In some examples, some opcodes (e.g., opcodes for operations executed by the same type of functional unit) are mapped to the same normalized token (or normalized code). In some examples, the tokens corresponding to memory locations are lemmatized.

In some examples, encoding a sequence of tokens (e.g., sequence 730 or a subset thereof) further involves obtaining embeddings (e.g., vector embeddings) representing each of the tokens in an embedding space (e.g., a latent embedding space). In some examples, the normalized codes corresponding to the tokens in the sequence 730 are used as indexes to retrieve the corresponding embeddings from a lookup table (e.g., array) of embeddings. In the example of FIG. 7B, vector 761 is the retrieved embedding corresponding to the normalized code ‘5’, which represents the opcode ‘v_and_b32’, whereas vectors 762 and 779 are the retrieved embedding corresponding to the normalized code ‘3’, which represents all vector registers (including ‘vt2’ and ‘vt6’).

The embeddings corresponding to the normalized codes can be generated using any suitable technique. In some examples, text-based descriptions of the concepts associated with a token (or group of tokens) corresponding to a normalized code are obtained (e.g., from a user) and mapped to the embedding space. For example, the concepts corresponding to token 712 and token 729 (vector registers ‘vt2’ and ‘vt6’) can include ‘vector register’, and the concepts corresponding to token 711 (′v_and_b32′) can include ‘opcode’, ‘bitwise operator’, ‘Boolean operator’, ‘32-bit vector elements’, etc.

In step 630, the feature generator 420 combines the encoded tokens (e.g., vector embeddings 761-779) to form one or more features 760 representing (e.g., characterizing) the basic block. In some examples, combining the encoded tokens involves concatenating the encoded tokens (e.g., arranging the encoded tokens in a sequence corresponding to the original token sequence 730). In some examples, if the number of tokens in the basic block is lower than a minimum number of tokens permitted by the scheduling model 430, one or more encoded tokens can be added to the end of the sequence as padding. In some examples, if the number of tokens in the basic block is higher than a maximum number of tokens permitted by the scheduling model 430, the feature generator 420 truncates the sequence of encoded tokens (e.g., discards the encodings of the tokens that exceed the maximum threshold). Alternatively, one or more pooling layers can be used to down-sample the combined encodings of token sequences that exceed the maximum threshold.

In general, the above-described acts of tokenizing the representation 700 of the basic block and normalizing the tokens tend to compress the information conveyed by the representation of the basic block such that a scheduling model M₁ that operates on the generated feature 760 can be significantly more efficient (e.g., have a smaller footprint and/or run faster) than a scheduling model M₂ that operates directly on the representation 700 of the basic block, while sacrificing very little performance (e.g., predictive accuracy) relative to M₂.

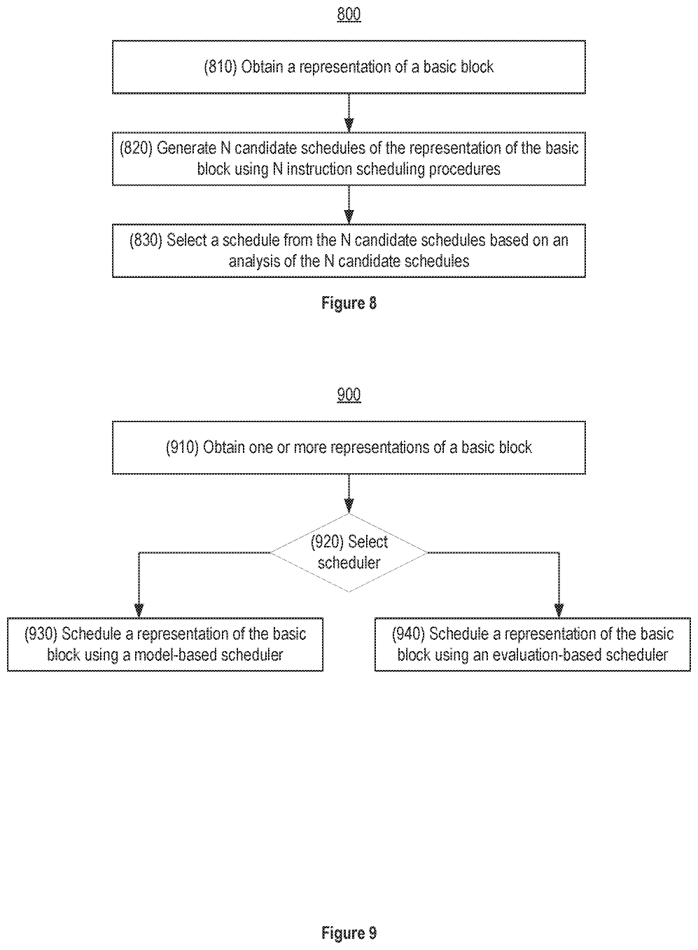

FIG. 8 is a flow diagram of an example evaluation-based method 800 for instruction scheduling. The evaluation-based scheduling method 800 can be performed, for example, by an instruction scheduler 325 of a compiler. In contrast to the model-based scheduling method 500 of FIG. 5, which uses predictive modeling to screen out a subset of N instruction scheduling procedures before generating candidate schedules with the remaining K scheduling procedures, the evaluation-based scheduling method 800 involves using all N instruction scheduling procedures to generate N candidate schedules for a basic block.

In some examples, the evaluation-based scheduling method 800 includes steps 810-830. In step 810, the instruction scheduler 325 obtains a representation of a basic block. Some non-limiting examples of techniques for obtaining a representation of a basic block are described herein. In step 820, the instruction scheduler 325 generates N candidate schedules of the representation of the basic block using N instruction scheduling procedures. Some non-limiting examples of techniques for generating a candidate schedule of a basic block using an instruction scheduling procedure are described herein. In step 830, the instruction scheduler 325 selects a schedule for the basic block (e.g., the ‘best’ schedule) from the set of N candidate schedules based on analysis (e.g., evaluation) of the N candidate schedules. Some non-limiting examples of techniques for analyzing a set of candidate schedules and selecting the best schedule in the set are described herein.

FIG. 9 is a flow diagram of an example hybrid method 900 for instruction scheduling. The hybrid scheduling method 900 can be performed, for example, by a target code generator 320 of a compiler. In some examples, the hybrid scheduling method 900 involves using different instruction scheduling techniques (e.g., different instruction schedulers 325) to schedule different subsets of the basic blocks of a computer program.

In some examples, the hybrid scheduling method 900 includes steps 910-940. In step 910, the target code generator 320 obtains one or more representations of a basic block. Some non-limiting examples of techniques for obtaining representations of a basic block are described herein.

In step 920, the target code generator 320 selects a scheduler 325 to schedule the basic block. For example, the target code generator 320 can select a scheduler 325 configured to perform the model-based scheduling method 500, a scheduler 325 configured to perform the evaluation-based scheduling method 800, or any other suitable scheduler 325. The target code generator 320 can select a scheduler 325 for the basic block based on any suitable criteria (e.g., the length of the basic block (e.g., number of instructions in the representation of the basic block), the type(s) of instructions in the representation of the basic block, the criticality of the basic block to the overall performance of the computer program being compiled, etc.). The inventors have observed that selecting a scheduler 325 for a basic block based on the length of the basic block can improve the computational efficiency of the compiler, because (1) some examples of the model-based scheduling method 500 have a non-trivial amount of computational overhead irrespective of the length of the basic block being scheduled but do not use significantly more computational resources as the length of the basic block increases from a few instructions to a few thousand instructions, whereas (2) some examples of the evaluation-based scheduling method 800 have very little computational overhead but use significantly more computational resources as the length of the basic block increases. Thus, in some examples, the evaluation-based scheduling method 800 is more computationally efficient than the model-based scheduling method 500 for shorter basic blocks (e.g., basic blocks having fewer than M instructions, where M is any suitable number, for example, 10, 20, 50, 100, 150, 200, 250, 300, 350, 400, 500, etc.). Likewise, in some examples, the model-based scheduling method 500 is more computationally efficient than the evaluation-based scheduling method 800 for longer basic blocks (e.g., basic blocks having more than M instructions). Thus, in some examples, the target code generator 320 selects the scheduler 325 configured to perform the model-based scheduling method 500 if the length of the basic block exceeds the threshold M, and selects the scheduler 325 configured to perform the evaluation-based scheduling method 800 if the length of the basic block does not exceed the threshold M. In this way, the hybrid scheduling method 900 can significantly improve the computational efficiency of the compiler's instruction scheduling phase, which yields a non-trivial improvement in the overall computational efficiency of the compiler 200.

If the target code generator 320 selects the model-based scheduler 325 to schedule the basic block in step 920, the hybrid scheduling method 900 proceeds to step 930. In step 930, the model-based scheduler 325 uses the model-based scheduling method 500 to schedule the basic block (e.g., to generate and/or select a schedule for the basic block).

If the target code generator 320 selects the evaluation-based scheduler 325 to schedule the basic block in step 920, the hybrid scheduling method 900 proceeds to step 940. In step 940, the evaluation-based scheduler 325 uses the evaluation-based scheduling method 800 to schedule the basic block (e.g., to generate and/or select a schedule for the basic block).

Some examples of AI-based techniques for guiding an instruction scheduler have been described. In some examples, these AI-based techniques are incorporated into an open-source compiler. In some examples, these AI-based techniques can be applied to any type of process (e.g., industrial manufacturing process, etc.) to schedule the steps of the process; the disclosed techniques are not limited to scheduling instructions of computer programs.

Some examples have been described in which a scheduler 400 uses a scheduling model 430 to identify the K-best scheduling procedures for a basic block from a set of N scheduling procedures. In some examples, the feature generator 420 and/or scheduling model 430 (collectively, “AI model”) is/are accessed by the scheduler 400 via an inference runtime (e.g., ONNX). In some examples, rather than creating a new session with the runtime whenever the scheduler 400 queries the AI model for a prediction of the K-best scheduling procedures for a basic block, the scheduler initializes a runtime session once (e.g., when the compiler begins the scheduling phase for a computer program) and reuses that same session to send multiple queries to the AI model and receive multiple responses from the AI model during compilation.

Techniques operating according to the principles described herein can be implemented in any suitable manner. While the foregoing disclosure sets forth various implementations using specific block diagrams, flow diagrams, and examples, each block diagram component, flow diagram step, operation, and/or component described and/or illustrated herein can be implemented, individually and/or collectively, using a wide range of configurations of hardware, software, or firmware (or any combination thereof). In addition, any disclosure of components contained within other components should be considered as non-limiting examples since many other architectures can be implemented to achieve the same functionality.

Included in the discussion above are flow diagrams showing steps and acts of instruction scheduling methods. The processing and decision blocks of the flow diagrams above represent steps and acts that can be included in algorithms that carry out these processes. Algorithms derived from these processes can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flow diagram(s) included herein do not depict the syntax or operation of any particular circuit or of any particular programming language or type of programming language. Rather, the flow diagram(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flow diagram is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, modules, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application, for example as a software program application such as compiler 200, compiler front end 220, compiler back end 240, target code generator (244 or 320), instruction scheduler(s) (325 or 400), feature generator 420, scheduling model 430, scheduling modules 440, or evaluation module 460. In other implementations, the functional facilities can be adapted to interact with other functional facilities in such a way as form an operating system, including the Windows operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described are merely illustrative of the types of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

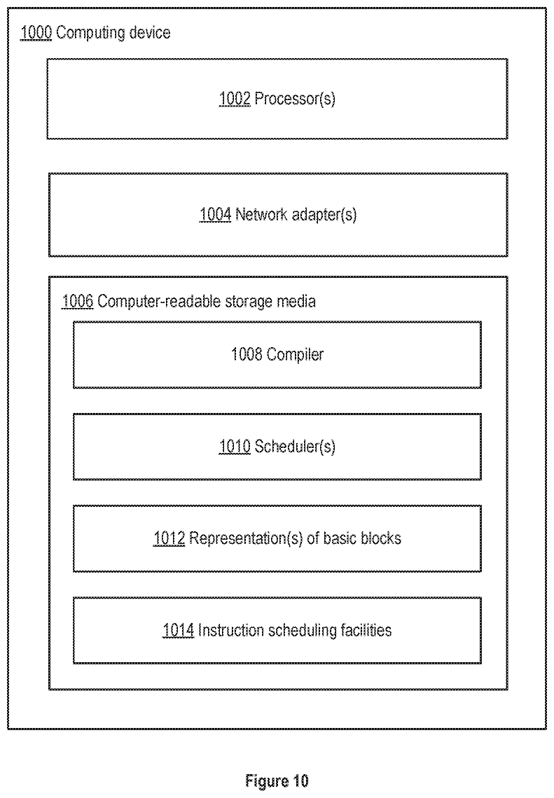

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as computer-readable storage media 1006 of FIG. 10 described below (i.e., as a portion of a computing device 1000) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 10 illustrates one exemplary implementation of a computing device in the form of a computing device 1000 that can be used in a system implementing the techniques described herein, although others are possible. It should be appreciated that FIG. 10 is intended neither to be a depiction of necessary components for a computing device to operate in accordance with the principles described herein, nor a comprehensive depiction.

Computing device 1000 can comprise at least one processor 1002, a network adapter 1004, and computer-readable storage media 1006. Computing device 1000 can be, for example, a desktop or laptop personal computer, a personal digital assistant (PDA), a smart mobile phone, a server, a wireless access point or other networking element, or any other suitable computing device. Network adapter 1004 can be any suitable hardware and/or software to enable the computing device 1000 to communicate wired and/or wirelessly with any other suitable computing device over any suitable computing network. The computing network can include wireless access points, switches, routers, gateways, and/or other networking equipment as well as any suitable wired and/or wireless communication medium or media for exchanging data between two or more computers, including the Internet. Computer-readable media 1006 can be adapted to store data to be processed and/or instructions to be executed by one or more processors 1002. Processor 1002 enables processing of data and execution of instructions. The data and instructions can be stored on the computer-readable storage media 1006.

The data and instructions stored on computer-readable storage media 1006 can comprise computer-executable instructions implementing techniques which operate according to the principles described herein. In the example of FIG. 10, computer-readable storage media 1006 stores computer-executable instructions implementing various facilities and storing various information as described above, including a compiler 1008 (e.g., compiler 200), one or more schedulers 1010 (e.g., schedulers 325, scheduler 400, etc.), one of more representations 1012 of basic blocks (e.g., intermediate representation 230, back-end representation 327, etc.), one or more instruction scheduling facilities 1014 (e.g., facilities implementing scheduling model 430, scheduling modules 440, scheduling methods 500, 600, 800, or 900, etc.), etc.

While not illustrated in FIG. 10, a computing device can additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A computer-implemented compilation method comprising:
scheduling a basic block of a computer program, including:
obtaining first and second representations of the basic block;
selecting K instruction scheduling procedures from a set of N instruction scheduling procedures, wherein the selecting of the K instruction scheduling procedures is based on analysis of the first representation of the basic block by one or more models, wherein 1≤K<N, and wherein N is at least 2;
generating K candidate schedules of the basic block, wherein generating the K candidate schedules includes applying the K instruction scheduling procedures to the second representation of the basic block, and
ordering a plurality of instructions of the second representation of the basic block in accordance with a candidate schedule included in the K candidate schedules of the basic block;
generating a portion of target code of the computer program based on the second representation of the basic block; and
outputting the portion of the target code of the computer program.

2. The method of claim 1, wherein the target code comprises object code executable by a central processing unit (CPU), an application processing unit (APU), an accelerated processing unit (APU), an inference processing unit (IPU), a graphics processing unit (GPU), a tensor processing unit (TPU), a field-programmable gate array (FPGA), programmable logic device (PLD), system-on-a-chip (SoC), network interface controller (NIC), data processing unit (DPU), data transform unit (DTU), a hardware accelerator, and/or a mobile processor.

3. The method of claim 2, further comprising executing the object code by the central processing unit (CPU), the application processing unit (APU), the accelerated processing unit (APU), the inference processing unit (IPU), the graphics processing unit (GPU), the tensor processing unit (TPU), the field-programmable gate array (FPGA), programmable logic device (PLD), system-on-a-chip (SoC), network interface controller (NIC), data processing unit (DPU), data transform unit (DTU), the hardware accelerator, and/or the mobile processor.

4. The method of claim 1, wherein the basic block is a first basic block, wherein scheduling the first basic block is performed by a first instruction scheduler of a compiler, and wherein scheduling a second basic block of the computer program includes, by a second instruction scheduler of the compiler:
generating N candidate schedules of the second basic block, wherein generating the N candidate schedules includes applying the N instruction scheduling procedures to a representation of the second basic block;
selecting a candidate schedule from the N candidate schedules of the second basic block based on an analysis of the generated N candidate schedules of the second basic block; and
ordering a plurality of instructions of the representation of the second basic block in accordance with the selected candidate schedule.

5. The method of claim 4, wherein the representation of the second basic block is a second representation, the method further comprising:
assigning the first basic block to the first instruction scheduler based on one or more attributes of the first representation of the first basic block; and
assigning the second basic block to the second instruction scheduler based on one or more attributes of the first representation of the second basic block not exceeding a threshold.

6. The method of claim 5, wherein the one or more attributes of the first representation of the basic block include a number of instructions in the first representation of the basic block exceeding a threshold.

7. The method of claim 1, wherein the selecting of the K instruction scheduling procedures from the set of N instruction scheduling procedures is performed after obtaining the analysis of the first representation of the basic block by the one or more models and before the generating of the K candidate schedules of the basic block.

8. The method of claim 1, wherein the first representation of the basic block is encoded in a machine-independent intermediate representation (IR) of a compiler, and wherein the second representation of the computer program is encoded in a machine-dependent IR of the compiler, in a target language associated with the compiler, or in an instruction set of a target processor.

9. The method of claim 1, wherein scheduling the basic block further includes obtaining the analysis of the first representation of the basic block, including:
generating one or more features based on the first representation of the basic block;
providing the one or more features as inputs to the one or more models; and
obtaining an output of the one or more models, the output indicating the K instruction scheduling procedures.

10. The method of claim 9, wherein generating the one or more features based on the first representation of the basic block includes generating a sequence of tokens based on the first representation of the basic block, encoding a plurality of tokens in the sequence of tokens, and combining the encoded plurality of tokens.

11. The method of claim 9, wherein the one or more models include a neural network, and wherein the neural network includes at least one pooling layer disposed between an input layer and an output layer.

12. The method of claim 1, wherein the target code comprises a plurality of instructions executable by a first type of processor, wherein the one or more models have been trained to identify a K-best subset of the set of N scheduling procedures for scheduling a basic block for execution by the first type of processor, and wherein the method further comprises retraining the one or more models to identify a K-best subset of the set of N scheduling procedures for scheduling a basic block for execution by a second type of processor.

13. The method of claim 12, wherein retraining the one or more models includes fine-tuning the one or more models based on analysis of a plurality of candidate schedules of a plurality of basic blocks each encoded in a representation dependent on the second type of processor.

14. The method of claim 1, further comprising:
generating a first representation of the computer program based on source code of the computer program, the first representation of the computer program including first representations of a plurality of basic blocks including the first basic block; and
generating a second representation of the computer program based on the first representation of the computer program, the second representation of the computer program including second representations of the plurality of basic blocks, the generating the second representation of the computer program including scheduling the plurality of basic blocks.

15. A compiler system comprising:
at least one processor; and
at least one computer-readable storage medium having encoded thereon instructions that, when executed by the at least one processor, cause the at least one processor to perform operations including:
generating a first representation of a computer program based on source code of the computer program, the first representation of the computer program including first representations of a plurality of basic blocks including a basic block;
generating a second representation of the computer program based on the first representation of the computer program, the second representation of the computer program including second representations of the plurality of basic blocks, the generating the second representation of the computer program including scheduling the plurality of basic blocks, wherein scheduling the basic block includes:
selecting K instruction scheduling procedures from a set of N instruction scheduling procedures, wherein the selecting of the K instruction scheduling procedures is based on analysis of the first representation of the first basic block by one or more models, wherein 1≤K<N, and wherein N is at least 2,
generating K candidate schedules of the basic block, wherein generating the K candidate schedules includes applying the K instruction scheduling procedures to the second representation of the basic block, and
ordering a plurality of instructions of the second representation of the basic block in accordance with a candidate schedule included in the K candidate schedules of the basic block;
generating target code of the computer program based on the second representation of the computer program; and
outputting the target code of the computer program.

16. The system of claim 15, wherein the target code comprises object code executable by a central processing unit (CPU), an application processing unit (APU), an accelerated processing unit (APU), an inference processing unit (IPU), a graphics processing unit (GPU), a tensor processing unit (TPU), a field-programmable gate array (FPGA), a hardware accelerator, and/or a mobile processor.

17. The system of claim 16, further comprising executing the object code by the central processing unit (CPU), the application processing unit (APU), the accelerated processing unit (APU), the inference processing unit (IPU), the graphics processing unit (GPU), the tensor processing unit (TPU), the field-programmable gate array (FPGA), the hardware accelerator, and/or the mobile processor.

18. The system of claim 15, wherein the at least one processor includes at least one first processor and at least one second processor, wherein the generating the K candidate schedules of the basic block is performed by the at least one first processor, and wherein scheduling the basic block further includes performing, by the at least one second processor, the analysis of the first representation of the basic block.

19. The system of claim 18, wherein performing the analysis of the first representation of the basic block comprises:
generating one or more features based on the first representation of the basic block;
providing the one or more features as inputs to the one or more models; and
obtaining an output of the one or more models, the output indicating the K instruction scheduling procedures.

20. At least one computer-readable storage medium encoded with computer-executable instructions that, when executed by at least one computer, cause the at least one computer to perform operations including:
scheduling a basic block of a computer program, including:
obtaining first and second representations of the basic block;
selecting K instruction scheduling procedures from a set of N instruction scheduling procedures, wherein the selecting of the K instruction scheduling procedures is based on analysis of the first representation of the basic block by one or more models, wherein 1≤K<N, and wherein Nis at least 2;
generating K candidate schedules of the basic block, wherein generating the K candidate schedules includes applying the K instruction scheduling procedures to the second representation of the basic block, and
ordering a plurality of instructions of the second representation of the basic block in accordance with a candidate schedule included in the K candidate schedules of the basic block;
generating a portion of target code of the computer program based on the second representation of the basic block; and
outputting the portion of target code of the computer program.
